(19) United States
(12) Patent Application Publication
(10) Pub. No.: US 2025/0365089 A1
(43) Pub. Date: Nov. 27, 2025

(54) OPTICAL TRANSMISSION APPARATUS AND OPTICAL TRANSMISSION METHOD

(71) Applicant: NTT, Inc., Tokyo (JP)

(72) Inventors: Shin KANEKO, Musashino-shi, Tokyo (JP); Junichi KANI, Musashino-shi, Tokyo (JP); Naotaka SHIBATA, Musashino-shi, Tokyo (JP); Takuya Kanai, Musashino-shi, Tokyo (JP)

(21) Appl. No.: 18/872,129

(22) PCT Filed: Jun. 7, 2022
(86) PCT No.: PCT/JP2022/022936

§ 371 Date: Dec. 5, 2024

(51) Int. Cl. H04J 14/02; H04B 10/50; H04B 10/572

(52) U.S. Cl. CPC H04J 14/021; H04B 10/506; H04B 10/572

(57) ABSTRACT

An optical transmission apparatus that transmits an optical signal between a communication terminal device and a network without converting the optical signal into an electrical signal includes: a plurality of multiplexing/demultiplexing units configured to receive and output optical signals from and to the communication terminal device connected to the optical transmission apparatus; a plurality of wavelength multiplexing/separating units configured to receive and output optical signals from and to the network connected to the optical transmission apparatus; and an optical distribution unit configured to output optical signals output from the multiplexing/demultiplexing units and subjected to predetermined electrical processing to a predetermined multiplexing/demultiplexing unit.

### TECHNICAL FIELD

The present invention relates to a technology of an optical transmission device and an optical transmission method.

### BACKGROUND ART

A conventional communication network generally includes access, metro, and a core networks, and has an architecture connecting these networks in a hierarchical manner. When traffic is transferred from the access to the metro, an optical signal is temporarily converted into an electrical signal at the boundary. Then, line concentration and multiplexing are performed in order to provide services to a larger number of users through a wider band optical path. The same applies to transfer of traffic from the metro to the core network. As a result, it is possible to achieve economy by sharing equipment between users or sharing equipment between services.

On the other hand, the line bandwidth per user and the line bandwidth per service are restricted. Therefore, at the time of transmitting large-capacity data such as high-definition video, data compression processing is required, which leads to occurrence of a large delay. In addition, a delay or jitter due to packet or frame waiting processing occurs at an electricity concentration point or multiple points.

On the other hand, a technique for eliminating the need for electrical termination of optical signals provided between layers in a conventional network has been proposed. In this technology, an access node is located at an access/metro boundary. The access node has a function of distributing an optical signal according to a route of an optical path having a device serving as a destination of the optical signal as an end point. With such a configuration, it is possible to provide a large-capacity and low-delay End-End optical path between arbitrary points. As a result, light through, folding, and extraction/insertion can be realized. The light through is a function of transferring an optical signal across the boundary between the access and metro. The folding is a function of directly connecting user devices accommodated in the same access node to each other by light. The extraction/insertion is a function for realizing reproduction relay/wavelength conversion or electrical processing at a network layer/service layer in a case where it is required.

### CITATION LIST

### Non Patent Literature

Non Patent Literature 1: S. Gringeri, B. Basch, V. Shukla, R. Egorov, and T. Xia, “Flexible architectures for optical transport nodes and networks”, IEEE Communications Magazine, vol. 48, no. 7, pp. 40-50, 2010.

### SUMMARY OF INVENTION

### Technical Problem

An optical transmission device 90 such as a reconfigurable optical add/drop multiplexer (ROADM) is one of optical nodes widely used in a metro network and the like in a conventional optical communication system. The optical transmission device 90 realizes efficient traffic transfer by connecting a plurality of bases. FIG. 13 is a diagram showing a configuration example of the conventional optical transmission device 90. The optical transmission device 90 shown in FIG. 13 includes a plurality of multiplexing/demultiplexing units 91, a plurality of wavelength multiplexing/separating units 92, and a control unit 99.

The multiplexing/demultiplexing units 91 are connected to a plurality of transponders 30 and the plurality of wavelength multiplexing/separating units 92. The multiplexing/demultiplexing units 91 output optical signals input from the transponders 30 to the wavelength multiplexing/separating units 92 connected to paths accommodating optical paths having the transponders 30 as end points. Further, the multiplexing/demultiplexing units 91 perform wavelength multiplexing on optical signals sharing a path. Further, the multiplexing/demultiplexing units 91 output optical signals input from the wavelength multiplexing/separating units 92 from ports connected to the transponders 30 which are destinations of the optical signals. The multiplexing/demultiplexing units 91 are implemented using a configuration in which an M×N multicast switch, an M×N wavelength selective switch (WSS), a 1×M WSS, and a 1×N WSS are combined, or the like. The M×N multicast switch includes, for example, M 1×N optical splitters/couplers and N M×1 optical switches.

The wavelength multiplexing/separating unit 92 is connected to the plurality of multiplexing/demultiplexing units 91 and the plurality of other wavelength multiplexing/separating units 92. The wavelength multiplexing/separating unit 92 performs wavelength multiplexing on wavelength-multiplexed optical signals input from each of the multiplexing/demultiplexing units 91 and each of the other wavelength multiplexing/separating units 92. The wavelength multiplexing/separating unit 92 outputs the wavelength-multiplexed optical signal from a network-side port. In addition, the wavelength multiplexing/separating unit 92 outputs an optical signal input from the network-side port to the multiplexing/demultiplexing units 91 and the other wavelength multiplexing/separating units 92 according to a route of an optical path having the transponder 30, which is a destination of the optical signal, as an end point. The wavelength multiplexing/separating unit 92 may be implemented by using a WSS, for example.

The control unit 99 controls operations of the multiplexing/demultiplexing units 91 and the wavelength multiplexing/separating units 92. Furthermore, the control unit 99 may assign a wavelength to the transponders 30. In the optical transmission device 90 such as an ROADM, an optical signal input from the transponder 30 is output from the network-side port of any one of the wavelength multiplexing/separating units 92 without being optically/electrically converted. In addition, an optical signal input from the network-side port of the wavelength multiplexing/separating unit 92 is output toward any of the transponders 30 without being optically/electrically converted. Therefore, in a case where this optical transmission device 90 is used as an access node, extraction/insertion cannot be realized. Therefore, processing such as reproduction relay, wavelength conversion, and electrical processing at a network layer/service layer cannot be realized.

In view of the above circumstances, an object of the present invention is to provide a technology that enables execution of electrical processing on a signal in an optical transmission system that transmits a signal without performing optical-to-electrical conversion.

### Solution to Problem

One aspect of the present invention is an optical transmission apparatus that transmits an optical signal between a communication terminal device and a network without converting the optical signal into an electrical signal, the optical transmission device including: a plurality of multiplexing/demultiplexing units configured to receive and output optical signals from and to the communication terminal device connected to the optical transmission apparatus; a plurality of wavelength multiplexing/separating units configured to receive and output optical signals from and to the network connected to the optical transmission apparatus; and an optical distribution unit configured to output optical signals output from the multiplexing/demultiplexing units and subjected to predetermined electrical processing to a predetermined multiplexing/demultiplexing unit.

One aspect of the present invention is an optical transmission method performed by an optical transmission device that transmits an optical signal between a communication terminal device and a network without converting the optical signal into an electrical signal, the optical transmission method including: a step in which the optical transmission device receives/outputs optical signals from/to the communication terminal device connected to the optical transmission apparatus; a step in which the optical transmission device receives/outputs optical signals from/to the network connected to the optical transmission apparatus; and a step in which the optical transmission device outputs an optical signal subjected to predetermined electrical processing to a predetermined multiplexing/demultiplexing unit.

### Advantageous Effects of Invention

According to the present invention, it is possible to perform electrical processing on a signal in an optical transmission system that transmits a signal without performing optical/electrical conversion.

### BRIEF DESCRIPTION OF DRAWINGS

FIG. 1 is a diagram showing a configuration example of an optical transmission system 100 in a first embodiment.

FIG. 2 is a diagram showing a first operation example in the first embodiment.

FIG. 3 is a diagram showing a second operation example in the first embodiment.

FIG. 4 is a diagram showing a configuration example of an optical transmission system 100 in a second embodiment.

FIG. 5 is a diagram showing a first operation example in the second embodiment.

FIG. 6 is a diagram showing a second operation example in the second embodiment.

FIG. 7 is a diagram showing a configuration example of an optical transmission system 100 in a third embodiment.

FIG. 8 is a diagram showing a first operation example in the third embodiment.

FIG. 9 is a diagram showing a second operation example in the third embodiment.

FIG. 10 is a diagram showing a configuration example of an optical transmission system 100 in a fourth embodiment.

FIG. 11 is a diagram showing a first operation example in the fourth embodiment.

FIG. 12 is a diagram showing a second operation example in the fourth embodiment.

FIG. 13 is a diagram showing a conventional optical transmission system.

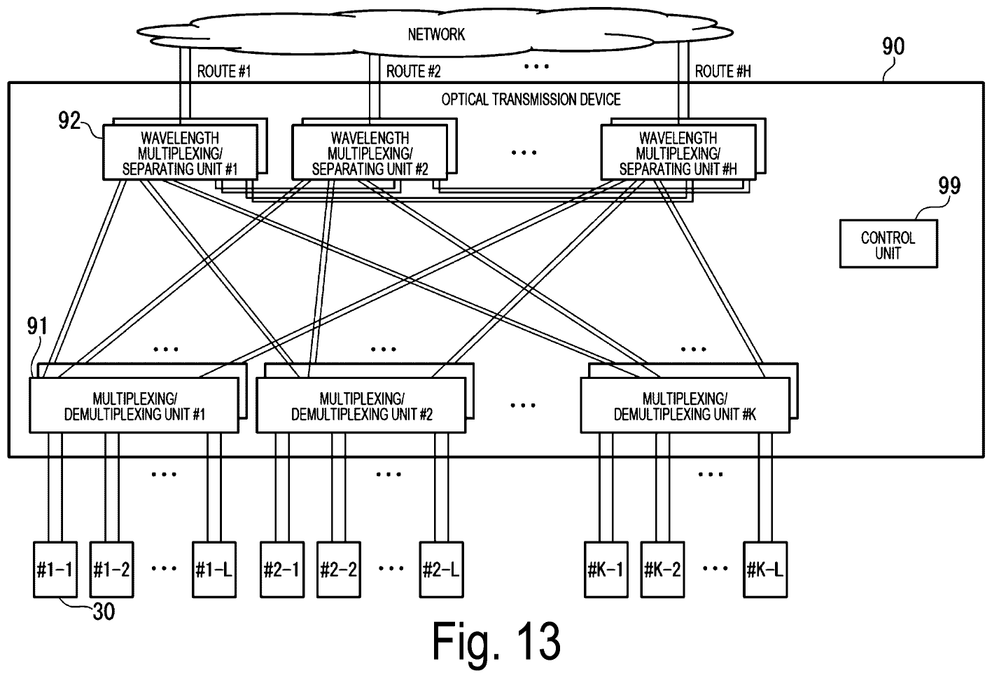

### DESCRIPTION OF EMBODIMENTS

Embodiments of the present invention will be described in detail with reference to the drawings.

### First Embodiment

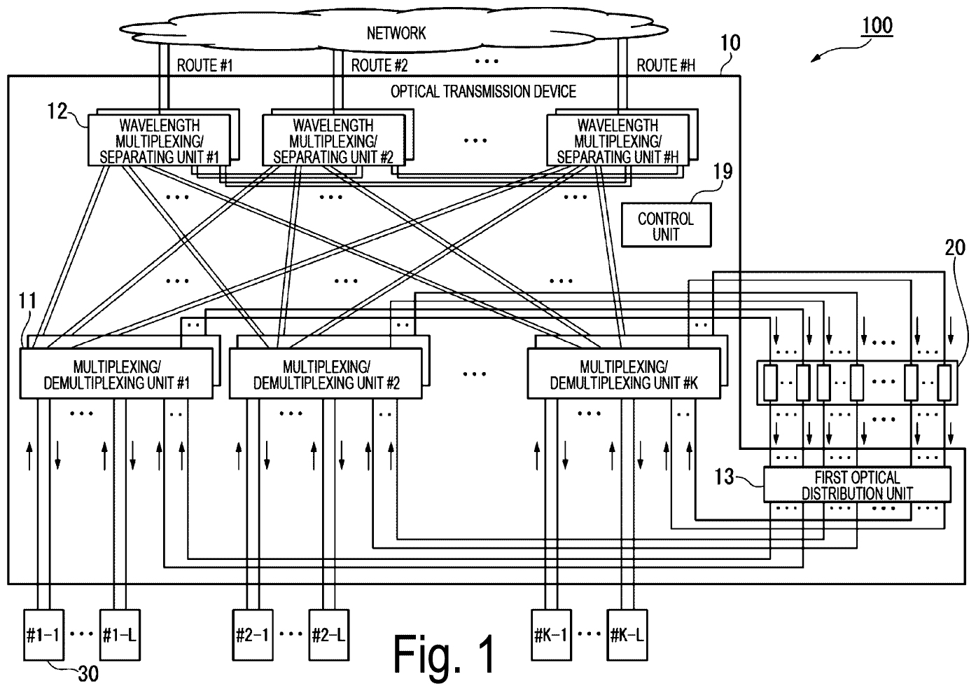

FIG. 1 is a diagram showing a configuration example of an optical transmission system 100 in a first embodiment. The optical transmission system 100 includes an optical transmission device 10 and an electrical processing unit 20. The optical transmission device 10 and the electrical processing unit 20 are connected to each other such that optical signals can be input and output therebetween. The optical transmission device 10 is connected to a network and transponders 30. The optical transmission device 10 is connected to another optical transmission device 10 via a network including optical fibers. In FIG. 1, the network is located above the optical transmission device 10. A position relatively close to the network is referred to as a “network side”. The transponders 30 are located below the optical transmission device 10. A position relatively close to the side of the transponders 30 is referred to as a “transponder side”.

The first embodiment is a configuration for realizing electrical processing on an optical signal on uplink from a lower side (transponder side) to an upper side (network side) in the figure.

The optical transmission device 10 includes a plurality of (K) multiplexing/demultiplexing units 11, a plurality of (H) wavelength multiplexing/separating units 12, a first optical distribution unit 13, and a control unit 19. K and H are each an integer of 2 or more. K and H may be the same value or different values.

Each of the multiplexing/demultiplexing units 11 is connected to a plurality of (L) transponders 30, the plurality of (H) wavelength multiplexing/separating units 12, the first optical distribution unit 13, and the electrical processing unit 20 such that optical signals can be input and output therebetween.

For uplink traffic from the lower side to the upper side in the figure, the multiplexing/demultiplexing unit 11 outputs an optical signal input from a transponder 30 to a wavelength multiplexing/separating unit 12 or the electrical processing unit 20. At this time, the wavelength multiplexing/separating unit 12 serving as an output destination is the wavelength multiplexing/separating unit 12 connected to a route accommodating an optical path having the transponder 30 serving as the transmission source of the optical signal as an end point. The multiplexing/demultiplexing unit 11 performs wavelength multiplexing on optical signals sharing a path and outputs the multiplexed optical signal. In a case where electrical processing by the electrical processing unit 20 is necessary for the output optical signal, the multiplexing/demultiplexing unit 11 outputs the optical signal to the electrical processing unit 20. Specific examples of electrical processing executed by the electrical processing unit 20 include reproduction relay, wavelength conversion, electrical processing at a network layer, electrical processing at a service layer, and the like.

For downlink traffic from the upper side to the lower side in the figure, the multiplexing/demultiplexing unit 11 outputs an optical signal input from a wavelength multiplexing/separating unit 12 toward a transponder 30. At this time, the multiplexing/demultiplexing unit 11 outputs the optical signal through a port to which the transponder 30 serving as the destination of the output optical signal is connected.

The multiplexing/demultiplexing unit 11 may be configured using, for example, an M×N multicast switch including M 1×N optical splitters/couplers and N M×1 optical switches. The multiplexing/demultiplexing unit 11 may be configured using, for example, an M×N WSS. The multiplexing/demultiplexing unit 11 may be configured using a device in which a 1×M WSS and a 1×N WSS are combined.

The wavelength multiplexing/separating unit 12 is connected to the plurality of (K) multiplexing/demultiplexing units 11 and a plurality of (H-1) other wavelength multiplexing/separating units 12 such that optical signals can be input and output therebetween. The wavelength multiplexing/separating unit 12 performs wavelength multiplexing on wavelength-multiplexed optical signals input from the multiplexing/demultiplexing unit 11 and another wavelength multiplexing/separating unit 12, and outputs the multiplexed optical signals from the network-side port to the network.

The wavelength multiplexing/separating unit 12 outputs an optical signal input from the network-side port to the multiplexing/demultiplexing unit 11 or another wavelength multiplexing/separating unit 12. At this time, the wavelength multiplexing/separating unit 12 selects the multiplexing/demultiplexing unit 11 or the wavelength multiplexing/separating unit 12 serving as the output destination according to the route of the optical path having the transponder 30 serving as the destination of the output optical signal as an end point.

The wavelength multiplexing/separating unit 12 may be configured using a WSS, for example.

The first optical distribution unit 13 is connected to the electrical processing unit 20 and the plurality of (K) multiplexing/demultiplexing units 11. The first optical distribution unit 13 distributes an optical signal output from the electrical processing unit 20 and outputs the optical signal toward the multiplexing/demultiplexing unit 11 with respect to uplink traffic. The first optical distribution unit 13 selects the multiplexing/demultiplexing unit 11 serving as the output destination according to the transponder 30 serving as the transmission source of the optical signal. With this configuration, an uplink optical signal input from the transponder 30 to the multiplexing/demultiplexing unit 11 can reach the wavelength multiplexing/separating unit 12 via the electrical processing unit 20 and the first optical distribution unit 13, and via another multiplexing/demultiplexing unit 11 different from the multiplexing/demultiplexing unit 11 to which the optical signal is initially input.

The first optical distribution unit 13 is configured using a device such as fiber cross connect (FXC). The FXC is configured using, for example, a MEMS or a piezo actuator. The FXC outputs light input from each port to a port at which a connection relationship is set as a connection port for the port regardless of the wavelength.

The control unit 19 includes a processor such as a central processing unit (CPU) and a memory. The control unit 19 may operate by a processor executing a program. The control unit 19 controls operations of the multiplexing/demultiplexing units 11 and the wavelength multiplexing/separating units 12. For example, the control unit 19 may control a connection relationship between ports in the multiplexing/demultiplexing units 11. Furthermore, the control unit 19 may assign a wavelength to the transponders 30.

In FIG. 1, the first optical distribution unit 13 is disposed at the subsequent stage of the electrical processing unit 20, but the first optical distribution unit 13 may be disposed at the preceding stage of the electrical processing unit 20. Further, in FIG. 1, a plurality of optical signals input to the electrical processing unit 20 are output from different ports, but the plurality of input optical signals may be output from the same port after electrical processing is executed. For example, in a case where a Muxponder function of multiplexing a plurality of signals and outputting the multiplexed signals as higher-speed optical signals is implemented in the electrical processing unit 20, the plurality of input optical signals is output from the same port. In FIG. 1, an uplink optical signal and a downlink optical signal flow through different optical fiber core wires. However, there may be a section in which each optical signal flows through the same optical fiber core wire.

Next, operation examples of the optical transmission device 10 will be described. The multiplexing/demultiplexing unit 11 may have a contention type configuration. The contention type is a configuration having no contentionless function. The contentionless function is a function of allowing signal light having the same wavelength to be simultaneously input from a plurality of ports. As a contention type multiplexing/demultiplexing unit 11, for example, there is a configuration in which a 1×M WSS and a 1×N WSS are combined. In this case, when an uplink optical signal input from the transponder 30 to the multiplexing/demultiplexing unit 11 is input to the same multiplexing/demultiplexing unit 11 as the multiplexing/demultiplexing unit 11 to which the optical signal has been initially input via the electrical processing unit 20 and the first optical distribution unit 13 without changing the wavelength, wavelength overlapping occurs in the multiplexing/demultiplexing unit 11. Therefore, in a case in which electrical processing by the electrical processing unit 20 is required for the uplink optical signal input from the transponder 30 to the multiplexing/demultiplexing unit 11, operations illustrated in a first operation example or a second operation example are required.

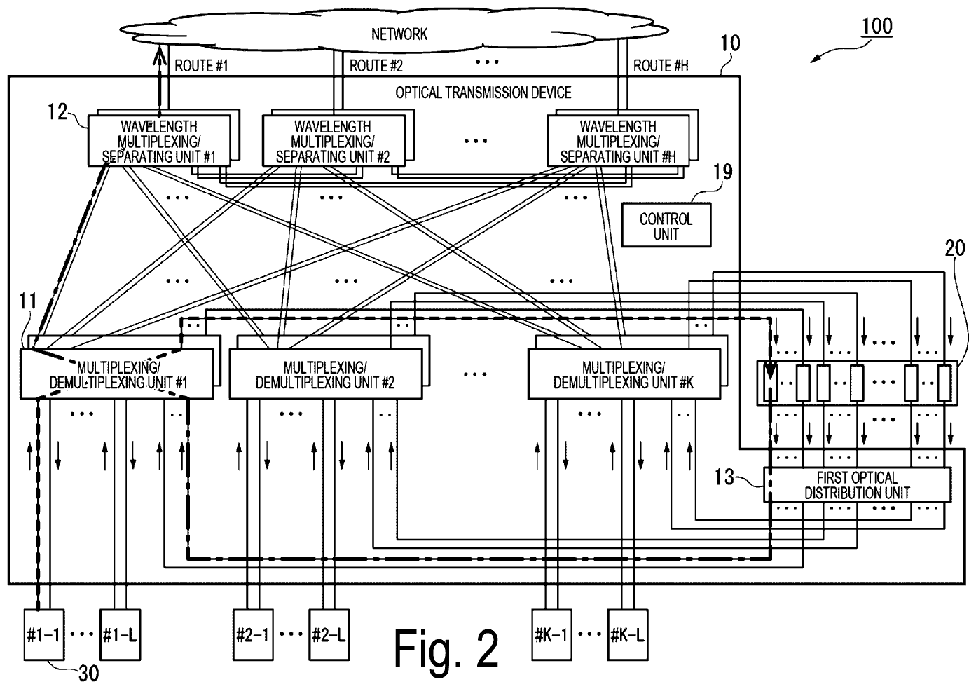

FIG. 2 is a diagram showing the first operation example in the first embodiment. In the first operation example, the electrical processing unit 20 converts the wavelength of an optical signal input thereto into a wavelength different from the wavelength of an optical signal output from the transponder 30, and outputs the converted signal. Therefore, even if the first optical distribution unit 13 outputs an optical signal to the same multiplexing/demultiplexing unit 11 (#1) as the multiplexing/demultiplexing unit 11 (#1) to which the optical signal is input from the transponder 30, wavelength overlapping does not occur. Therefore, the first optical distribution unit 13 can output the optical signal to the same multiplexing/demultiplexing unit 11 (#1) as the multiplexing/demultiplexing unit 11 (#1) to which the optical signal has been input from the transponder 30. At this time, the wavelength of the optical signal output from the electrical processing unit 20 is different from the wavelength of an optical signal input from another transponder 30 to the multiplexing/demultiplexing unit 11 or the wavelength of another optical signal input from the electrical processing unit 20 to the multiplexing/demultiplexing unit 11.

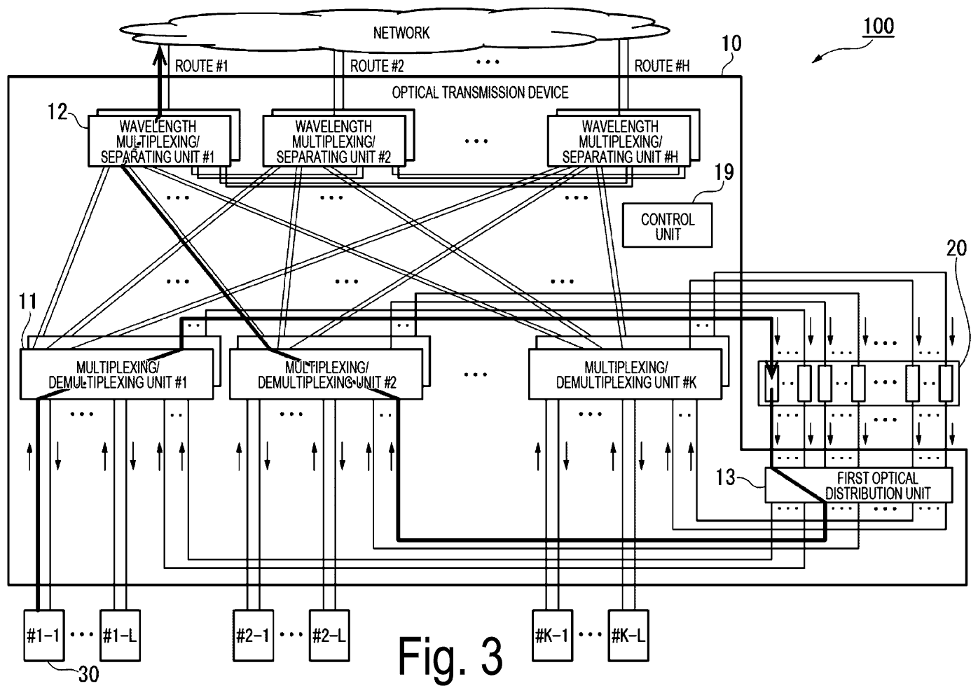

FIG. 3 is a diagram showing the second operation example in the first embodiment. In the second operation example, the first optical distribution unit 13 outputs an optical signal to a multiplexing/demultiplexing unit 11 (for example, #2) different from the multiplexing/demultiplexing unit 11 (#1) to which an optical signal has been input from the transponder 30. The wavelength of the optical signal output from the electrical processing unit 20 is different from the wavelength of an optical signal input from another transponder 30 to the multiplexing/demultiplexing unit 11 (for example, #2) at the second time or the wavelength of another optical signal input from the electrical processing unit 20. By assigning the wavelength in this manner, even in a case in which the multiplexing/demultiplexing unit 11 is of the contention type, wavelength conversion before input to and after output from the electrical processing unit 20 can be made unnecessary in the second operation example. As a result, in the second operation example, wavelength resource management becomes easy.

### Second Embodiment

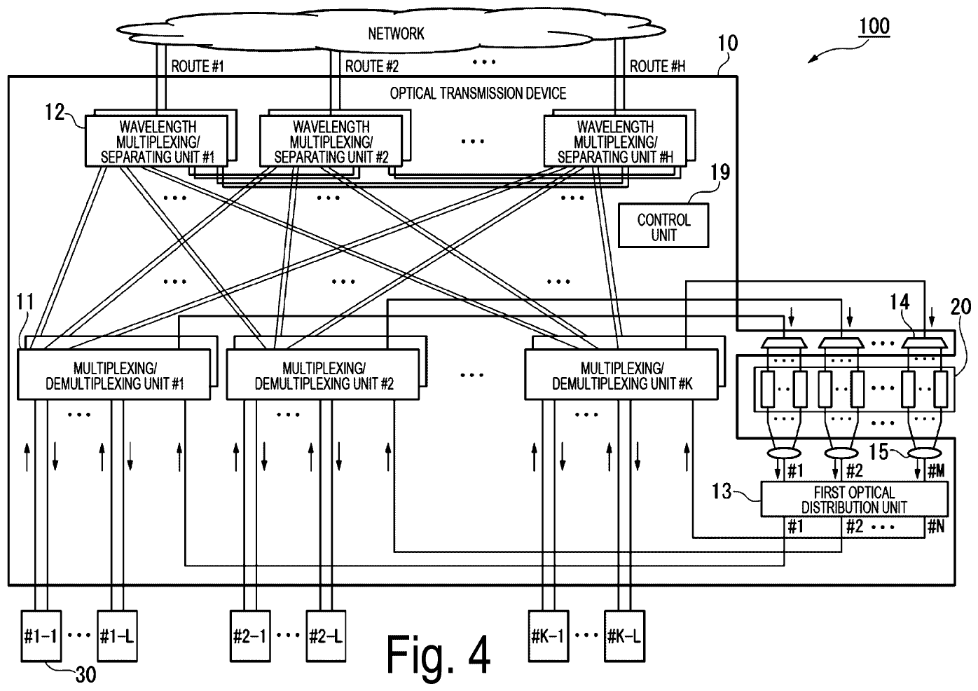

A second embodiment is a configuration for realizing electrical processing on an optical signal on uplink from the lower side (transponder side) to the upper side (network side) in the figure. FIG. 4 is a diagram showing a configuration example of an optical transmission system 100 in a second embodiment. In the first embodiment, uplink optical signals output from the multiplexing/demultiplexing unit 11 to the electrical processing unit 20 are output from different ports without being wavelength-multiplexed. On the other hand, in the second embodiment, the multiplexing/demultiplexing unit 11 performs wavelength multiplexing on a plurality of uplink optical signals output to the electrical processing unit 20 and outputs the multiplexed optical signal. Therefore, a wavelength separation unit 14 that separates and outputs the wavelength-multiplexed uplink optical signal for each wavelength is provided in the preceding stage of the electrical processing unit 20 (between the multiplexing/demultiplexing unit 11 that outputs the optical signal and the electrical processing unit 20).

The wavelength separation unit 14 may be configured using a device such as an arrayed waveguide grating (AWG) or a WSS, for example. In the second embodiment, with such a configuration, the number of ports on the network side (upper side in FIG. 4) of the multiplexing/demultiplexing units 11 can be reduced.

In addition, an optical multiplexing unit 15 may be provided at the subsequent stage of the electrical processing unit 20 in order to perform wavelength multiplexing on the optical signal output from the electrical processing unit 20. In the second embodiment, with such a configuration, the number of ports of the first optical distribution unit 13 can be reduced.

The optical multiplexing unit 15 may be configured using, for example, an optical coupler including an optical fiber or a planar lightwave circuit (PLC). The optical coupler has no wavelength dependency. Therefore, the optical multiplexing unit 15 configured using the optical coupler can transfer the optical signal output from the electrical processing unit 20 to the first optical distribution unit 13 regardless of the wavelength thereof.

In the second embodiment, the first optical distribution unit 13 may be configured using, for example, FXC or Wavelength Cross Connect (WXC). The WXC outputs light input from each port to a port at which a connection relationship is set as a connection port for each wavelength. The WXC may be configured by, for example, combining an M×1 WSS and a 1×N WSS, or may be configured using an M×N WSS. The optical multiplexing unit 15 performs wavelength multiplexing on an optical signal output from the first optical distribution unit 13 to the same multiplexing/demultiplexing unit 11 and outputs the signal. According to such an operation, the number of ports on the transponder side (lower side in the figure) of the multiplexing/demultiplexing units 11 can be reduced.

The control unit 19 includes a processor such as a CPU and a memory. The control unit 19 may operate by a processor executing a program. The control unit 19 controls operations of the multiplexing/demultiplexing units 11 and the wavelength multiplexing/separating units 12. For example, the control unit 19 may control a connection relationship between ports in the multiplexing/demultiplexing units 11. Furthermore, the control unit 19 may assign a wavelength to the transponders 30.

In the second embodiment, in a case in which the multiplexing/demultiplexing unit 11 has a contention type configuration, the optical transmission system 100 may operate according to the first operation example or the second operation example described below.

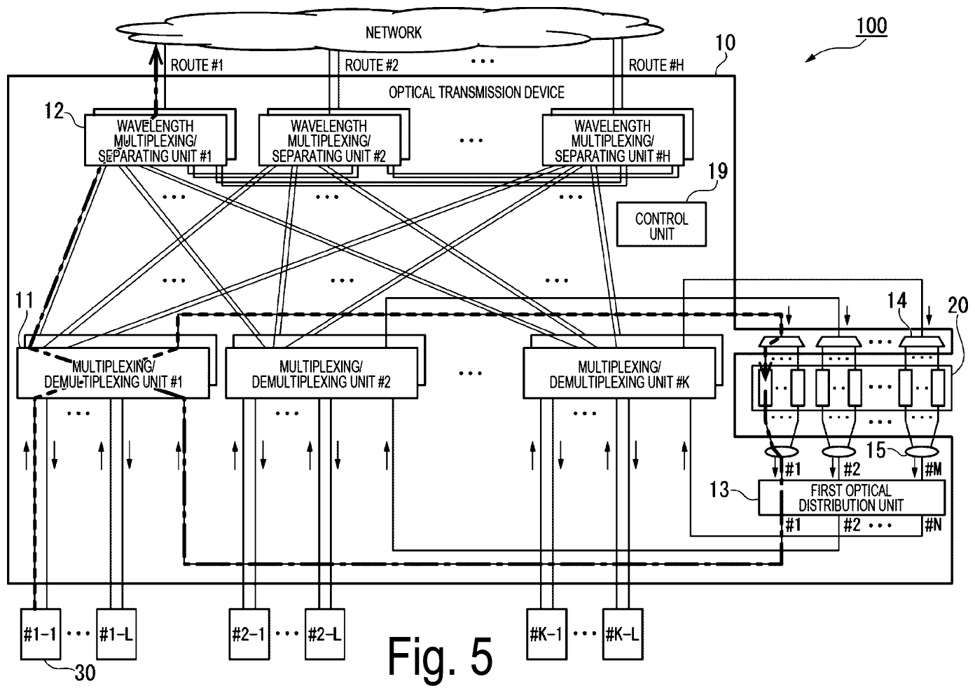

FIG. 5 is a diagram showing the first operation example in the second embodiment. In the first operation example, the electrical processing unit 20 converts the wavelength of an optical signal input thereto into a wavelength different from the wavelength of an optical signal output from the transponder 30, and outputs the converted signal. Therefore, even if the first optical distribution unit 13 outputs an optical signal to the same multiplexing/demultiplexing unit 11 (#1) as the multiplexing/demultiplexing unit 11 (#1) to which the optical signal is input from the transponder 30, wavelength overlapping does not occur. Therefore, the first optical distribution unit 13 can output the optical signal to the same multiplexing/demultiplexing unit 11 (#1) as the multiplexing/demultiplexing unit 11 (#1) to which the optical signal has been input from the transponder 30. At this time, the wavelength of the optical signal output from the electrical processing unit 20 is different from the wavelength of an optical signal input from another transponder 30 to the multiplexing/demultiplexing unit 11 (#1) or the wavelength of another optical signal input from the electrical processing unit 20 to the multiplexing/demultiplexing unit 11 (#1).

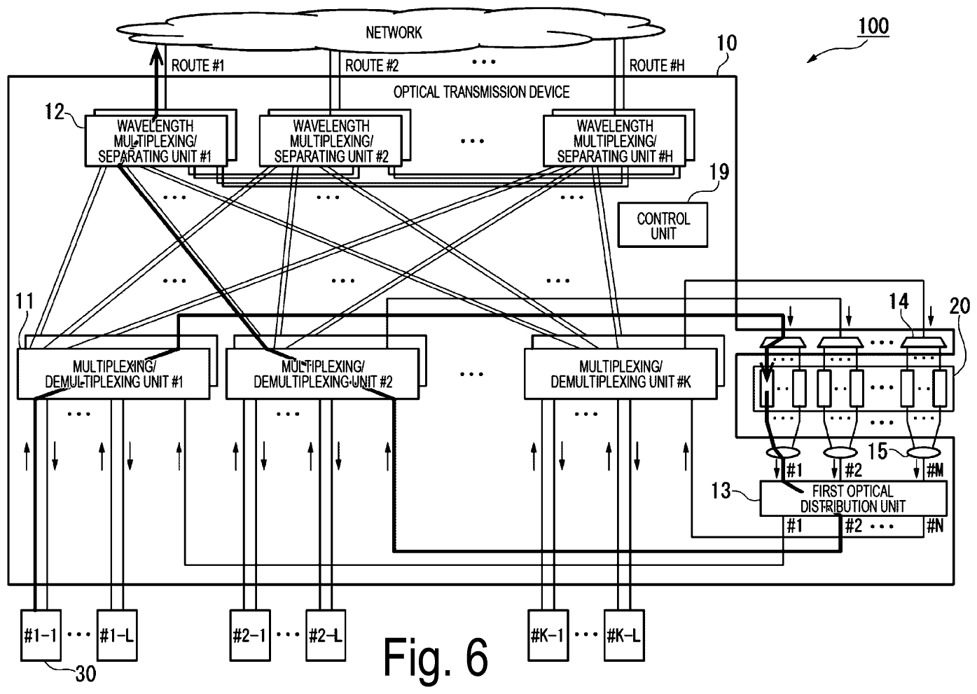

FIG. 6 is a diagram showing the second operation example in the second embodiment. In the second operation example, the first optical distribution unit 13 outputs an optical signal to a multiplexing/demultiplexing unit 11 (for example, #2) different from the multiplexing/demultiplexing unit 11 (#1) to which an optical signal has been input from the transponder 30. The wavelength of the optical signal output from the electrical processing unit 20 is different from the wavelength of an optical signal input from another transponder 30 to the multiplexing/demultiplexing unit 11 (for example, #2) at the second time or the wavelength of another optical signal input from the electrical processing unit 20. By assigning the wavelength in this manner, even in a case in which the multiplexing/demultiplexing unit 11 is of the contention type, wavelength conversion before input to and after output from the electrical processing unit 20 can be made unnecessary in the second operation example. As a result, in the second operation example, wavelength resource management becomes easy.

In the second embodiment, a part may also be modified similarly to the first embodiment. For example, in FIG. 4, a plurality of optical signals input to the electrical processing unit 20 are output from different ports, but the plurality of input optical signals may be output from the same port after electrical processing is executed. For example, in a case where a Muxponder function of multiplexing a plurality of signals and outputting the multiplexed signals as higher-speed optical signals is implemented in the electrical processing unit 20, the plurality of input optical signals is output from the same port. In FIG. 4, an uplink optical signal and a downlink optical signal flow through different optical fiber core wires. However, there may be a section in which each optical signal flows through the same optical fiber core wire.

### Third Embodiment

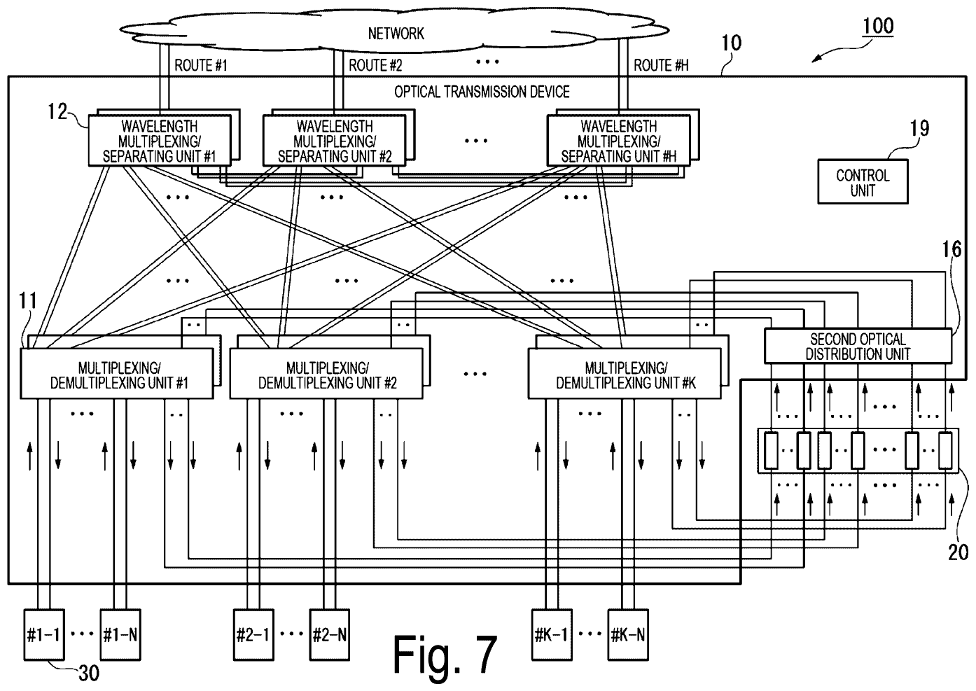

A third embodiment is a configuration for realizing electrical processing on an optical signal on downlink from the upper side (network side) to the lower side (transponder side) in the figure. FIG. 7 is a diagram showing a configuration example of an optical transmission system 100 in the third embodiment.

An optical transmission device 10 includes a plurality of (K) multiplexing/demultiplexing units 11, a plurality of (H) wavelength multiplexing/separating units 12, and a second optical distribution unit 16. K and H are each an integer of 2 or more. K and H may be the same value or different values.

Each of the multiplexing/demultiplexing units 11 is connected to a plurality of (N) transponders 30, the plurality of (H) wavelength multiplexing/separating units 12, the second optical distribution unit 16, and an electrical processing unit 20 such that optical signals can be input and output therebetween.

For uplink traffic from the lower side to the upper side in the figure, the multiplexing/demultiplexing units 11 output optical signals input from the transponders 30 to the wavelength multiplexing/separating units 12. At this time, the wavelength multiplexing/separating unit 12 serving as an output destination is the wavelength multiplexing/separating unit 12 connected to a route accommodating an optical path having the transponder 30 serving as the transmission source of the optical signal as an end point. The multiplexing/demultiplexing unit 11 performs wavelength multiplexing on optical signals sharing a path and outputs the multiplexed optical signal.

For downlink traffic from the upper side to the lower side in the figure, the multiplexing/demultiplexing units 11 output optical signals input from the wavelength multiplexing/separating units 12 to the transponders 30 or the electrical processing unit 20. At this time, the multiplexing/demultiplexing unit 11 outputs the optical signal through a port to which the transponder 30 serving as the destination of the output optical signal is connected. In a case where electrical processing by the electrical processing unit 20 is necessary for the output optical signal, the multiplexing/demultiplexing unit 11 outputs the optical signal to the electrical processing unit 20. Specific examples of electrical processing executed by the electrical processing unit 20 include reproduction relay, wavelength conversion, electrical processing at a network layer, electrical processing at a service layer, and the like.

The multiplexing/demultiplexing unit 11 may be configured using, for example, an M×N multicast switch including M 1×N optical splitters/couplers and N M×1 optical switches. The multiplexing/demultiplexing unit 11 may be configured using, for example, an M×N WSS. The multiplexing/demultiplexing unit 11 may be configured using a device in which a 1×M WSS and a 1×N WSS are combined.

The wavelength multiplexing/separating unit 12 is connected to the plurality of (K) multiplexing/demultiplexing units 11 and a plurality of (H-1) other wavelength multiplexing/separating units 12 such that optical signals can be input and output therebetween. The wavelength multiplexing/separating unit 12 performs wavelength multiplexing on wavelength-multiplexed optical signals input from the multiplexing/demultiplexing unit 11 and another wavelength multiplexing/separating unit 12, and outputs the multiplexed optical signals from the network-side port to the network.

The wavelength multiplexing/separating unit 12 outputs an optical signal input from the network-side port to the multiplexing/demultiplexing unit 11 or another wavelength multiplexing/separating unit 12. At this time, the wavelength multiplexing/separating unit 12 selects the multiplexing/demultiplexing unit 11 or the wavelength multiplexing/separating unit 12 serving as the output destination according to the route of the optical path having the transponder 30 serving as the destination of the output optical signal as an end point.

The wavelength multiplexing/separating unit 12 may be configured using a WSS, for example.

The second optical distribution unit 16 is connected to the electrical processing unit 20 and the plurality of (K) multiplexing/demultiplexing units 11. The second optical distribution unit 16 distributes an optical signal output from the electrical processing unit 20 and outputs the optical signal toward the multiplexing/demultiplexing units 11 with respect to downlink traffic. The second optical distribution unit 16 selects a multiplexing/demultiplexing unit 11 serving as an output destination according to the transponder 30 serving as a transmission source of the optical signal. With this configuration, a downlink optical signal input from the wavelength multiplexing/separating unit 12 to the multiplexing/demultiplexing unit 11 can reach the transponder 30 via the electrical processing unit 20 and the second optical distribution unit 16, and via another multiplexing/demultiplexing unit 11 different from the multiplexing/demultiplexing unit 11 to which the optical signal has been initially input.

The second optical distribution unit 16 is configured using a device such as FXC. The FXC is configured using, for example, a MEMS or a piezo actuator. The FXC outputs light input from each port to a port at which a connection relationship is set as a connection port for the port regardless of the wavelength.

The control unit 19 includes a processor such as a CPU and a memory. The control unit 19 may operate by a processor executing a program. The control unit 19 controls operations of the multiplexing/demultiplexing units 11 and the wavelength multiplexing/separating units 12. For example, the control unit 19 may control a connection relationship between ports in the multiplexing/demultiplexing units 11. Furthermore, the control unit 19 may assign a wavelength to the transponders 30.

In FIG. 7, the second optical distribution unit 16 is disposed at the subsequent stage of the electrical processing unit 20, but the second optical distribution unit 16 may be disposed at the preceding stage of the electrical processing unit 20. Further, in FIG. 7, a plurality of optical signals input to the electrical processing unit 20 are output from different ports, but the plurality of input optical signals may be output from the same port after electrical processing is executed. For example, in a case where a Muxponder function of multiplexing a plurality of signals and outputting the multiplexed signals as higher-speed optical signals is implemented in the electrical processing unit 20, the plurality of input optical signals is output from the same port. In FIG. 7, an uplink optical signal and a downlink optical signal flow through different optical fiber core wires. However, there may be a section in which each optical signal flows through the same optical fiber core wire.

Next, operation examples of the optical transmission device 10 will be described. The multiplexing/demultiplexing unit 11 may have a contention type configuration. The contention type is a configuration having no contentionless function. The contentionless function is a function of allowing signal light having the same wavelength to be simultaneously input from a plurality of ports. As a contention type multiplexing/demultiplexing unit 11, for example, there is a configuration in which a 1×M WSS and a 1×N WSS are combined. In this case, when a downlink optical signal input from the wavelength multiplexing/separating unit 12 to the multiplexing/demultiplexing unit 11 is input to the same multiplexing/demultiplexing unit 11 as the multiplexing/demultiplexing unit 11 to which the optical signal has been initially input via the electrical processing unit 20 and the second optical distribution unit 16 without changing the wavelength, wavelength overlapping occurs in the multiplexing/demultiplexing unit 11. Therefore, in a case in which electrical processing by the electrical processing unit 20 is required for the downlink optical signal input from the wavelength multiplexing/separating unit 12 to the multiplexing/demultiplexing unit 11, the operation illustrated in the first operation example or the second operation example is required.

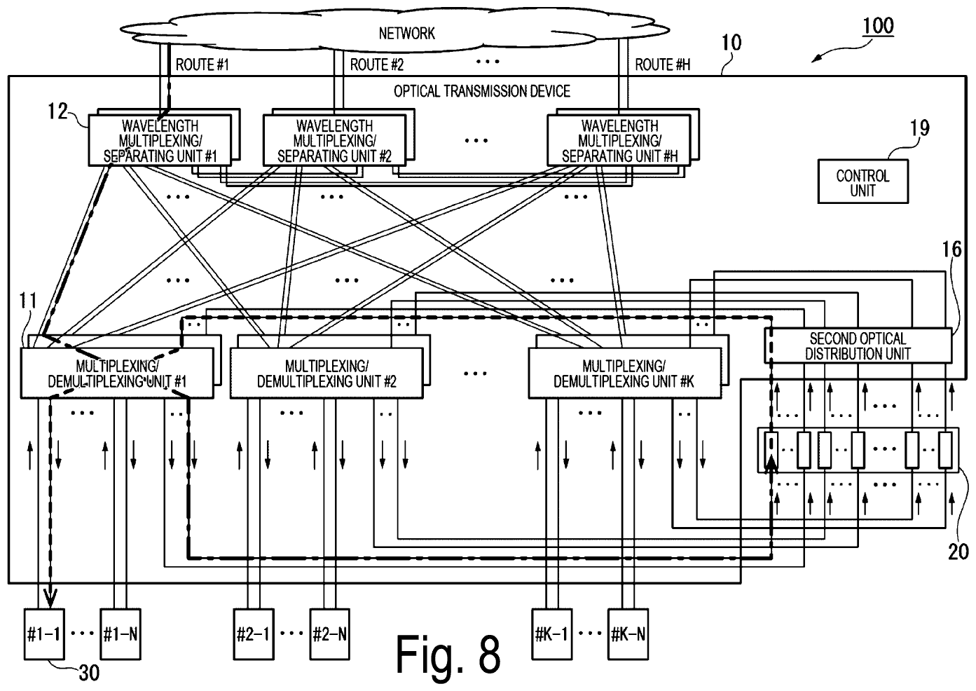

FIG. 8 is a diagram showing the first operation example in the third embodiment. In the first operation example, the electrical processing unit 20 converts the wavelength of an optical signal input thereto into a wavelength different from the wavelength of an optical signal output from the wavelength multiplexing/separating unit 12, and outputs the converted signal. Therefore, even if the second optical distribution unit 16 outputs an optical signal to the same multiplexing/demultiplexing unit 11 (#1) as the multiplexing/demultiplexing unit 11 (#1) to which the optical signal has been input from the wavelength multiplexing/separating unit 12, wavelength overlapping does not occur. Therefore, the second optical distribution unit 16 can output an optical signal to the same multiplexing/demultiplexing unit 11 (#1) as the multiplexing/demultiplexing unit 11 (#1) to which the optical signal has been input from the wavelength multiplexing/separating unit 12. At this time, the wavelength of the optical signal output from the electrical processing unit 20 is different from the wavelength of the optical signal input from the wavelength multiplexing/separating unit 12 to the multiplexing/demultiplexing unit 11 or the wavelength of another optical signal input from the electrical processing unit 20 to the multiplexing/demultiplexing unit 11.

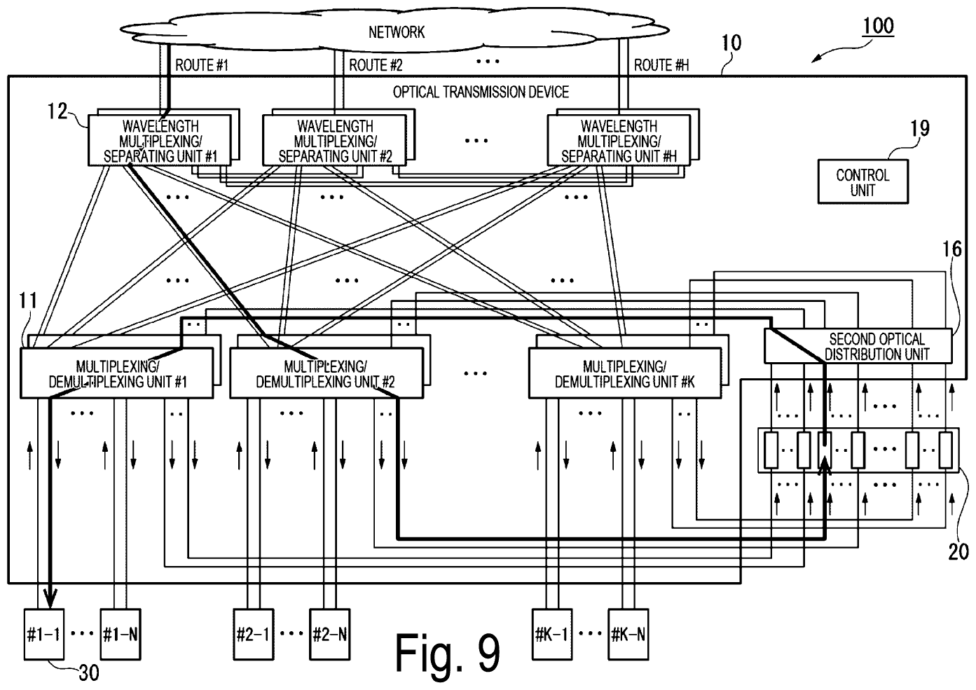

FIG. 9 is a diagram showing the second operation example in the third embodiment. In the second operation example, the second optical distribution unit 16 outputs an optical signal to a multiplexing/demultiplexing unit 11 (for example, #2) different from the multiplexing/demultiplexing unit 11 (#1) to which an optical signal has been input from the wavelength multiplexing/separating unit 12. The wavelength of an optical signal output from the electrical processing unit 20 is different from the wavelength of an optical signal input from the wavelength multiplexing/separating unit 12 to the multiplexing/demultiplexing unit 11 (for example, #2) at the second time or the wavelength of another optical signal input from the electrical processing unit 20. By assigning the wavelength in this manner, even in a case in which the multiplexing/demultiplexing unit 11 is of the contention type, wavelength conversion before input to and after output from the electrical processing unit 20 can be made unnecessary in the second operation example. As a result, in the second operation example, wavelength resource management becomes easy.

### Fourth Embodiment

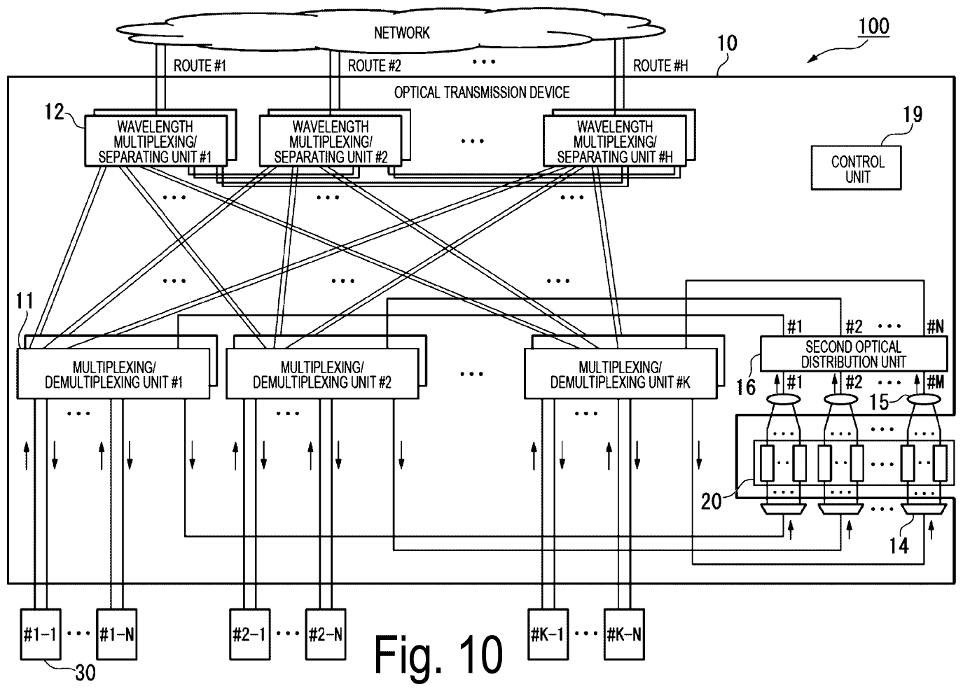

A fourth embodiment is a configuration for realizing electrical processing on an optical signal on downlink from the upper side (network side) to the lower side (transponder side) in the figure. FIG. 10 is a diagram showing a configuration example of an optical transmission system 100 in the fourth embodiment. In the third embodiment, downlink optical signals output from the multiplexing/demultiplexing unit 11 to the electrical processing unit 20 are output from different ports without being wavelength-multiplexed. On the other hand, in the fourth embodiment, the multiplexing/demultiplexing unit 11 performs wavelength multiplexing on a plurality of downlink optical signals output to the electrical processing unit 20 and outputs the multiplexed optical signal. Therefore, a wavelength separation unit 14 that separates and outputs the wavelength-multiplexed downlink optical signal for each wavelength is provided in the preceding stage of the electrical processing unit 20 (between the multiplexing/demultiplexing unit 11 that outputs the optical signal and the electrical processing unit 20).

The wavelength separation unit 14 may be configured using a device such as an arrayed waveguide grating (AWG) or a WSS, for example. In the fourth embodiment, with such a configuration, the number of ports on the transponder side (the lower side in FIG. 10) of the multiplexing/demultiplexing units 11 can be reduced.

In addition, an optical multiplexing unit 15 may be provided at the subsequent stage of the electrical processing unit 20 in order to perform wavelength multiplexing on the optical signal output from the electrical processing unit 20. In the fourth embodiment, with such a configuration, the number of ports of the second optical distribution unit 16 can be reduced.

The optical multiplexing unit 15 may be configured using, for example, an optical coupler including an optical fiber or a planar lightwave circuit (PLC). The optical coupler has no wavelength dependency. Therefore, the optical multiplexing unit 15 configured using the optical coupler can transfer the optical signal output from the electrical processing unit 20 to the second optical distribution unit 16 regardless of the wavelength thereof.

The control unit 19 includes a processor such as a CPU and a memory. The control unit 19 may operate by a processor executing a program. The control unit 19 controls operations of the multiplexing/demultiplexing units 11 and the wavelength multiplexing/separating units 12. For example, the control unit 19 may control a connection relationship between ports in the multiplexing/demultiplexing units 11. Furthermore, the control unit 19 may assign a wavelength to the transponders 30.

In the fourth embodiment, the second optical distribution unit 16 may be configured using, for example, FXC or WXC. The WXC outputs light input from each port to a port at which a connection relationship is set as a connection port for each wavelength. The WXC may be configured by, for example, combining an M×1 WSS and a 1×N WSS, or may be configured using an M×N WSS. The optical multiplexing unit 15 performs wavelength multiplexing on an optical signal output from the second optical distribution unit 16 to the same multiplexing/demultiplexing unit 11 and outputs the signal. According to such an operation, the number of ports on the network side (upper side in the figure) of the multiplexing/demultiplexing units 11 can be reduced.

In the fourth embodiment, in a case in which the multiplexing/demultiplexing unit 11 has a contention type configuration, the optical transmission system 100 may operate according to the first operation example or the second operation example described below.

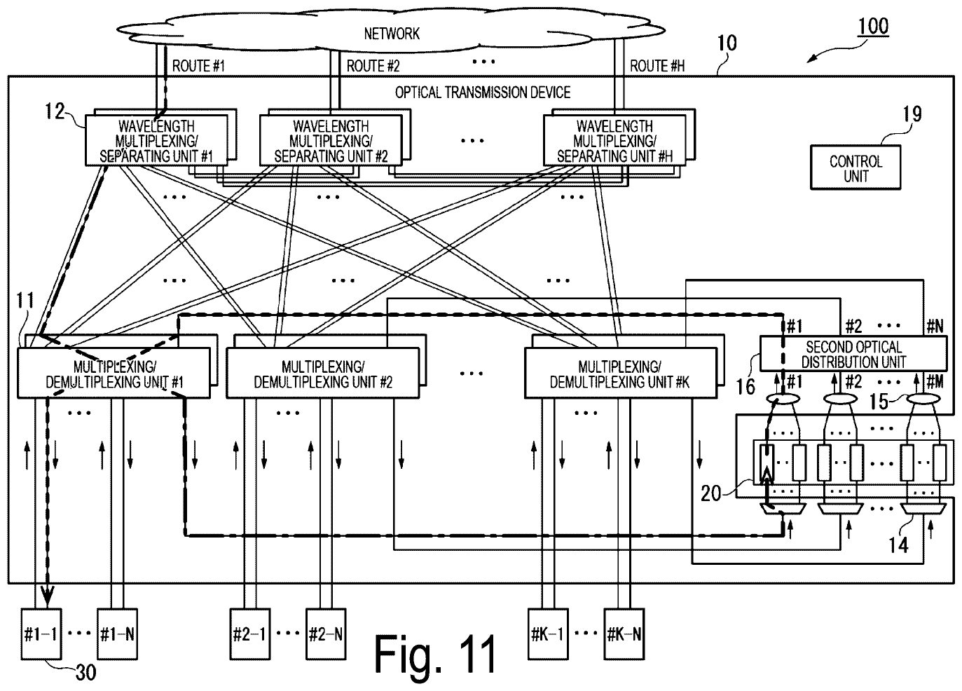

FIG. 11 is a diagram showing the first operation example in the fourth embodiment. In the first operation example, the electrical processing unit 20 converts the wavelength of an optical signal input thereto into a wavelength different from the wavelength of an optical signal output from the wavelength multiplexing/separating unit 12, and outputs the converted signal. Therefore, even if the second optical distribution unit 16 outputs an optical signal to the same multiplexing/demultiplexing unit 11 (#1) as the multiplexing/demultiplexing unit 11 (#1) to which the optical signal has been input from the wavelength multiplexing/separating unit 12, wavelength overlapping does not occur. Therefore, the second optical distribution unit 16 can output an optical signal to the same multiplexing/demultiplexing unit 11 (#1) as the multiplexing/demultiplexing unit 11 (#1) to which the optical signal has been input from the wavelength multiplexing/separating unit 12. At this time, the wavelength of the optical signal output from the electrical processing unit 20 is different from the wavelength of an optical signal input from the wavelength multiplexing/separating unit 12 to the multiplexing/demultiplexing unit 11 (#1) or the wavelength of another optical signal input from the electrical processing unit 20 to the multiplexing/demultiplexing unit 11 (#1).

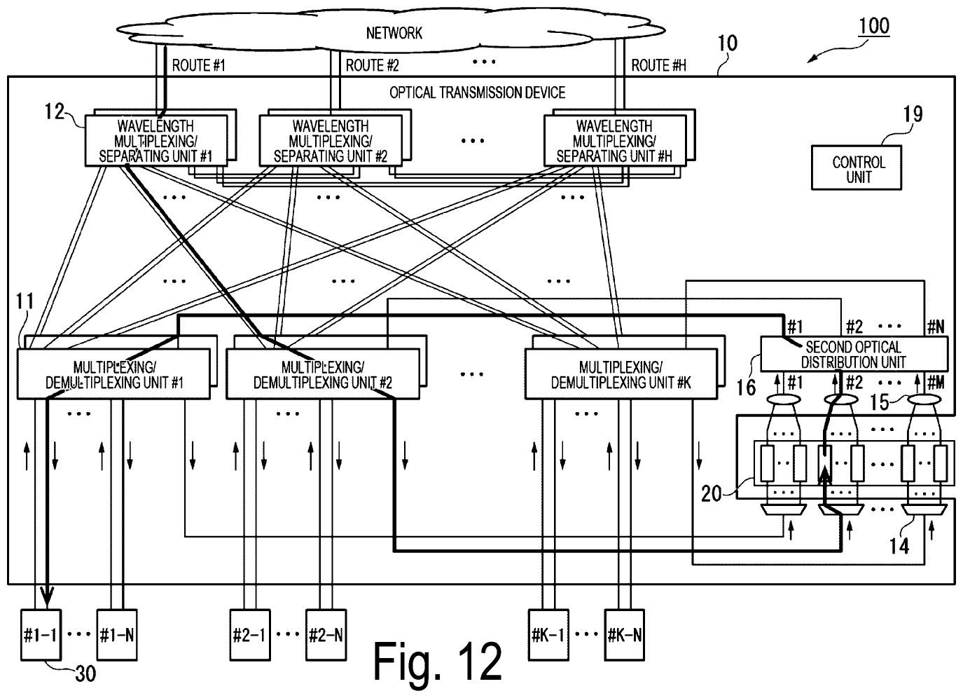

FIG. 12 is a diagram showing the second operation example in the fourth embodiment. In the second operation example, the second optical distribution unit 16 outputs an optical signal to a multiplexing/demultiplexing unit 11 (for example, #2) different from the multiplexing/demultiplexing unit 11 (#1) to which an optical signal has been input from the wavelength multiplexing/separating unit 12. The wavelength of an optical signal output from the electrical processing unit 20 is different from the wavelength of an optical signal input from the wavelength multiplexing/separating unit 12 to the multiplexing/demultiplexing unit 11 (for example, #2) at the second time or the wavelength of another optical signal input from the electrical processing unit 20. By assigning the wavelength in this manner, even in a case in which the multiplexing/demultiplexing unit 11 is of the contention type, wavelength conversion before input to and after output from the electrical processing unit 20 can be made unnecessary in the second operation example. As a result, in the second operation example, wavelength resource management becomes easy.

In the fourth embodiment, a part may also be modified similarly to the third embodiment. For example, in FIG. 10, the plurality of optical signals input to the electrical processing unit 20 are output from different ports, but the plurality of input optical signals may be output from the same port after electrical processing is executed. For example, in a case where a Muxponder function of multiplexing a plurality of signals and outputting the multiplexed signals as higher-speed optical signals is implemented in the electrical processing unit 20, the plurality of input optical signals is output from the same port. In FIG. 10, an uplink optical signal and a downlink optical signal flow through different optical fiber core wires. However, there may be a section in which each optical signal flows through the same optical fiber core wire.

### Fifth Embodiment

The optical transmission system 100 may be configured by combining the configuration of the first embodiment or the second embodiment and the configuration of the third embodiment or the fourth embodiment. With this configuration, it is possible to perform electrical processing on both an uplink signal transmitted from the transponder 30 to the network side and a downlink signal transmitted from the network side to the transponder 30.

Although the embodiments of the present invention have been described in detail with reference to the drawings, the specific configuration is not limited to the embodiments, and includes design and the like within a range not departing from the gist of the present invention.

### INDUSTRIAL APPLICABILITY

The present invention is applicable to optical communication networks using an optical switch.

### REFERENCE SIGNS LIST

100 Optical transmission system
10 Optical transmission device
11 Multiplexing/demultiplexing unit
12 Wavelength multiplexing/separating unit
13 First optical distribution unit
14 Wavelength separation unit
15 Optical multiplexing unit
16 Second optical distribution unit
19 Control unit
20 Electrical processing unit
30 Transponder (communication terminal device)

1. An optical transmission apparatus that transmits an optical signal between a communication terminal device and a network without converting the optical signal into an electrical signal, the optical transmission device comprising:
a plurality of multiplexer/demultiplexier configured to receive and output optical signals from and to the communication terminal device connected to the optical transmission apparatus;
a plurality of wavelength multiplexer/separator configured to receive and output optical signals from and to the network connected to the optical transmission apparatus; and
an optical distributer configured to output optical signals output from the multiplexer/demultiplexier and subjected to predetermined electrical processing to a predetermined multiplexer/demultiplexier.

2. The optical transmission device according to claim 1, wherein the optical distributer outputs an optical signal on which predetermined electrical processing has been executed and a wavelength of which has been changed to the same multiplexer/demultiplexier as a multiplexer/demultiplexier through which the optical signal has already passed.

3. The optical transmission device according to claim 1, wherein the optical distributer outputs an optical signal on which predetermined electrical processing has been executed to a multiplexer/demultiplexier different from a multiplexer/demultiplexier through which the optical signal has already passed.

4. An optical transmission method performed by an optical transmission apparatus that transmits an optical signal between a communication terminal device and a network without converting the optical signal into an electrical signal, the optical transmission method comprising:
a step in which the optical transmission apparatus receives/outputs optical signals from/to the communication terminal device connected to the optical transmission apparatus;
a step in which the optical transmission apparatus receives/outputs optical signals from/to the network connected to the optical transmission apparatus; and
an optical distribution step in which the optical transmission apparatus outputs optical signals subjected to predetermined electrical processing to a predetermined multiplexer/demultiplexier.
